(19) United States
(12) Patent Application Publication
(10) Pub. No.: US 2023/0375050 A1
(43) Pub. Date: Nov. 23, 2023

(54) Brake Application Mechanism of a Disc Brake

(71) Applicant: KNORR-BREMSE Systeme fuer Nutzfahrzeuge GmbH, Muenchen (DE)

(72) Inventors: Julian DAHLENBURG, Georgensgmuend (DE); Christian STOEGER, Osterhofen (DE); Andreas PETSCHKE, Neuburg am Inn (DE); Natalie ROTH, Aunkirchen (DE); Maximilian HAUSER, Fuerstenzell (DE); Michael HIDRINGER, Hofkirchen (DE); Thomas BECK, Passau (DE); Martin HEINDL, Eging am See (DE); Dimitrij HABERMANN, Stephansposching (DE); Thomas THALER, Beutelsbach (DE); Frederic SCHROEPF, Muenchen (DE); Thomas EICHLER, Muenchen (DE)

(21) Appl. No.: 18/027,498

(22) PCT Filed: Aug. 26, 2021
(86) PCT No.: PCT/EP2021/073618

§ 371 Date: Mar. 21, 2023

(30) Foreign Application Priority Data
Sep. 22, 2020 (DE) 10 2020 124 690.0

(51) Int. Cl. F16D 55/2255; F16D 65/18; F16D 65/56

(52) U.S. Cl. CPC F16D 55/2255; F16D 65/183; F16D 65/568; F16D 2121/14

(57) ABSTRACT

Disclosed is a brake application mechanism for a disc brake in a utility vehicle, having a pivotable brake lever that is supported on an inner wall of a brake caliper and, indirectly, on a bridge which is movably disposed in the brake caliper and which supports at least one brake pad, wherefor an axially and radially secured antifriction roller is disposed between the brake lever and the bridge. The disclosed brake application mechanism is designed such that the antifriction roller rests on the bridge in such a way as to be prevented from rotating and sliding.

### BACKGROUND AND SUMMARY

The invention relates to a brake-application device of a disc brake for a utility vehicle.

By means of such a brake-application device, which is a constituent part of a disc brake, brake pads can be pressed against a vehicle-side brake disc in a braking situation.

In this case, the brake-application device is actuated pneumatically or electromechanically with the aid of a pivotable brake lever which is supported, for the one part, on an inner wall of a brake caliper, and, for the other part, on a displaceable bridge, for which purpose there is arranged a roller bearing assembly in the form of a roller which is axially and radially secured between the brake lever and the bridge.

For mounting of the roller, a bearing shell is formed in the brake lever and is coated with a suitable plastic such that what is known as a DU bearing assembly is produced.

A correspondingly modified shaped part is in turn attached to the bridge for mounting of the roller, said shaped part moreover serving to radially and axially secure the roller and serving, by way of integrally formed projections, for example tabs or the like, as cage return guide for the cages of rolling bearings, by means of which the brake lever is mounted on the inner wall of the brake caliper in a smooth-running manner. Such a brake-application device is known from DE 103 07 734 B3.

In driving operation, however, it has been found that the roller has hitherto not been sufficiently secured against axial displacement, with the result that breakage of the tabs may occur. This has the possible consequence of a failure of the brake that cannot be identified from the outside, which of course represents an unacceptable safety risk.

Moreover, the freely rotatable mounting of the roller frequently leads to the abrasive removal of particles which ingress into the DU bearing of the brake lever, which in particular adversely affects the service life of the DU bearing assembly.

To remedy this, DE 10 2014 108 500 A1 proposes that the roller be held on the bridge so as to be secured against rotation and displacement. To this end, shaped regions which correspond to one another are provided on the bridge and the roller, for example in the form of flattened portions on the roller which bear against support surfaces of the bridge.

This construction has proven successful in terms of function. However, problems may arise during the assembly of the disc brake, in particular of the brake-application device, since the roller, as an individual part, is present as a loose part prior to the assembly, which makes the assembly more difficult insofar as a fixing prior to a final position is possible only with corresponding manufacturing outlay, i.e. an assembly aid.

In addition, the configuration both of the roller and of the bridge also becomes relatively complex, since the flattened portions of the roller and the support surfaces of the bridge are of planar configuration, which is possible only with a relatively complex machining operation.

The invention is based on the object of further developing a brake-application device of the generic type such that its service life is improved using structurally simple means and its assembly becomes easier.

This object is achieved by means of a brake-application device having the features of the independent claim.

The configuration of the brake-application device according to the invention in such a way that the at least one roller is virtually connected to the bridge by a securing element, a fixing of the roller, in relation to the bridge, in terms of an axial direction, a radial direction and a direction of rotation is ensured not only in an installed position of the brake-application device but also prior to installation in a brake caliper. That is to say that the bridge and the roller may be preassembled as a structural unit and be inserted without it being necessary to employ particular assembly measures to install the arrangement of the roller, said arrangement being known from the prior art and being loose in relation to the bridge.

Since disc brakes, the essential functional component of which is a brake-application device, are produced as series products in large quantities, particular importance is attached to this significant simplification of assembly which is possible by way of the configuration according to the invention, especially with regard to the minimization of costs.

In addition, the invention affords the advantage that the use of hitherto known shaped parts which are fastened to the bridge can be dispensed with, which also contributes to cost optimization.

In this context, it should also be noted that it is now possible to dispense with the use of a hardened steel for the manufacturing of the roller, which has up to now arisen from the steel/steel friction pairing between the shaped part in the form of a bearing shell and the roller.

The at least one securing element is held on the bridge and on the roller in a positively locking or frictionally locking manner, wherein, according to a further concept of the invention, the use of a clamping sleeve which is plugged both into a bore in the bridge and into a bore in the roller and which is held therein in a frictionally locking manner has proven to be particularly advantageous.

Such clamping sleeves are commercially available as standard parts and are therefore particularly inexpensive. For tolerance compensation, one of the bores, that is to say the bore in the bridge or the bore in the roller, may be in the form of an elongate hole in small dimensions.

In principle, however, the introduction of the bores is likewise very easy and significantly more inexpensive to produce than the flattened portions of the roller and of the bridge that are described with respect to the prior art.

Instead of clamping sleeves, dowel pins may also be inserted into the correspondingly prepared bores, these dowel pins also being held in the bridge and/or in the roller in a frictionally locking manner.

As a further embodiment variant of the securing elements, eyelets may be provided on the bridge, into which eyelets two coaxially oriented rollers which are arranged with a spacing to one another are pressed as roller bearing assembly by way of their mutually averted ends. This spacing of the rollers to one another, that is to say the intermediate space formed, is dimensioned such that the rollers can be plugged in without any problems.

The eyelets are expediently formed integrally on the bridges which are composed of cast iron. This embodiment variant also ensures a more secure hold, that is to say that the rollers are secured against rotation and displacement.

Furthermore, the securing element may consist of a sheet-metal piece which is pressed both into a groove of the bearing point of the bridge and into a groove of the roller, this sheet-metal piece extending in a pivoting direction of the brake lever.

Further advantageous configurations of the invention are characterized in the dependent claims.

Exemplary embodiments of the invention will be described below on the basis of the appended drawings.

### BRIEF DESCRIPTION OF THE DRAWINGS

FIG. 1 shows a cross section of the schematic construction of a disc brake provided with a brake-application device according to the prior art.

FIG. 2 shows a perspective view of a detail of the disc brake according to an embodiment of the invention.

FIG. 3 shows a section through the detail along line III-III in FIG. 2.

FIG. 4 shows a perspective view of a bridge of the brake-application device.

FIG. 5 shows a diagrammatic illustration of a further exemplary embodiment of a brake-application device according to the invention.

FIG. 6 shows a section through the brake-application device according to FIG. 5 along line VI-VI in FIG. 5.

FIG. 7 shows a further variant of the brake-application device according to the invention, likewise in a perspective view.

FIG. 8 shows a longitudinal section of a further exemplary embodiment of the invention.

### DETAILED DESCRIPTION OF THE DRAWINGS

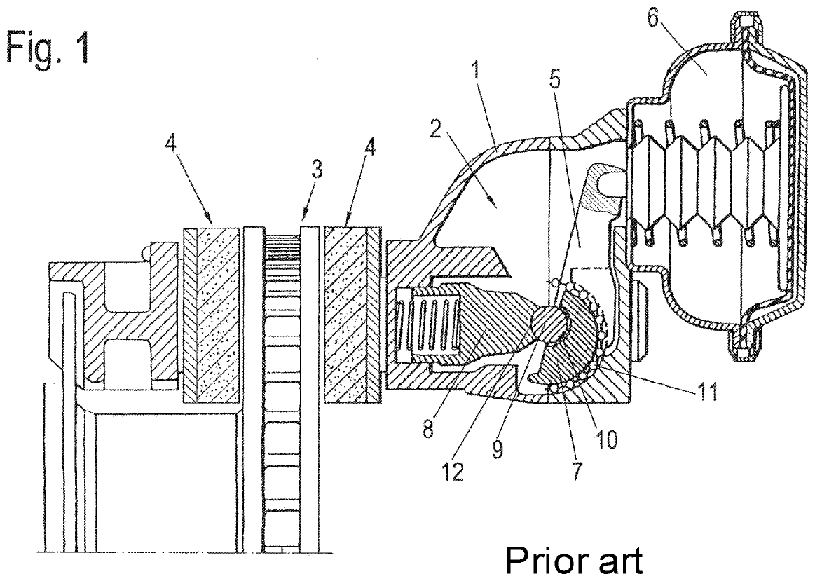

A disc brake for a utility vehicle according to the prior art is illustrated in section in FIG. 1. This disc brake has a brake disc 3 which is fastened to an axle (not shown) of the utility vehicle and which is encompassed by a brake caliper 1 which can be displaced in the direction of the brake disc 3.

Arranged in the brake caliper 1 is a brake-application device 2 by means of which brake pads 4 can be pushed against the brake disc 3 in the event of a braking situation triggered via a preferably pneumatically actuated brake cylinder.

The brake-application device 2 in this case engages with brake plungers (not illustrated) which are arranged parallel and with a spacing to one another in a bridge 8 and which are in the form of actuating spindles.

A brake lever 5 of the brake-application device 2 is operatively connected to the brake cylinder 6 and can, when actuated, pivot in the direction of the brake disc 3 about a roller 9 which runs parallel to the plane of the brake disc 3.

On the side opposite to the roller 9, the brake lever 5 bears against rolling bodies 11 which are each held in a cage and which are supported, for the one part, on the brake lever 5 which is in the form of an eccentric 7 in this region, and, for the other part, on an inner wall of the brake caliper 1.

The roller 9, as a constituent part of a roller bearing assembly, serves as rotary bearing for the brake lever 5 and lies in a bearing shell 10 of the eccentric 7. In this case, the cross section of the bearing shell 10 is adapted to the cross-sectional contour of the roller 9 in the same way as a concave channel 12 in which the roller 9 lies.

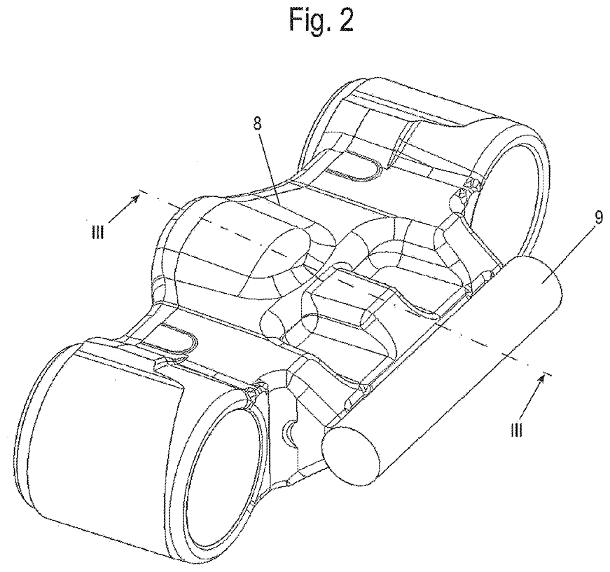

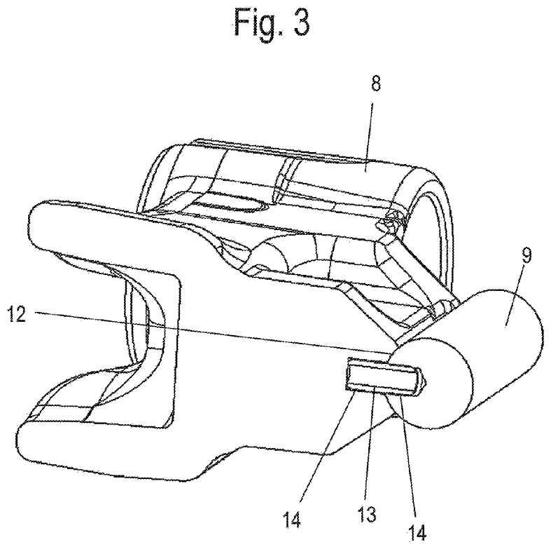

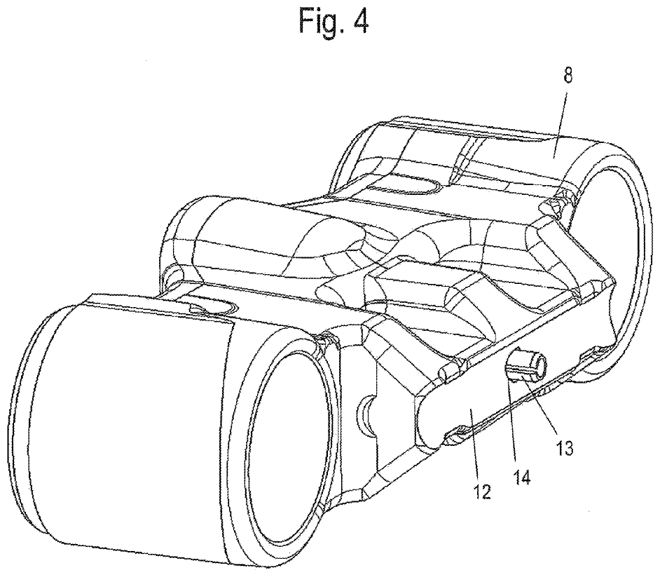

FIGS. 2-8 show embodiment variants of the brake-application device 2, which, according to the invention, have at least one securing element which is connected to the bridge 8 and to the roller 9.

The bridge 8 is depicted as a detail of the brake-application device 2 in FIGS. 2-4. In this example, the securing element consists of a clamping sleeve 13 which is plugged both into a bore 14 in the bridge 8 in the region of the channel 12 and into a bore 14 in the roller 9 and which is held therein in a frictionally locking manner.

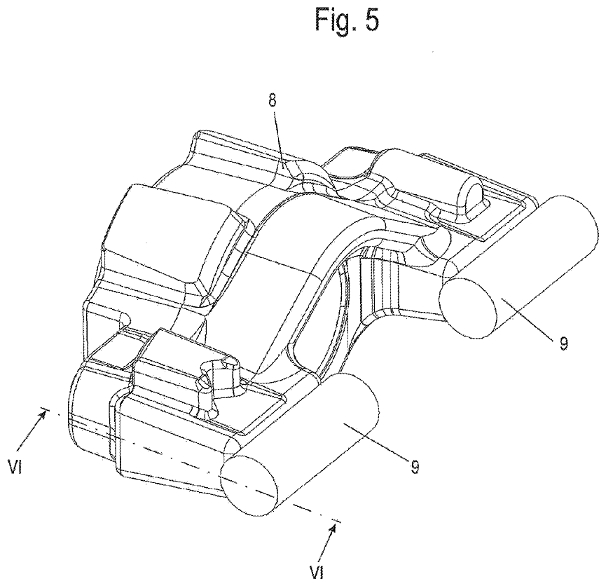

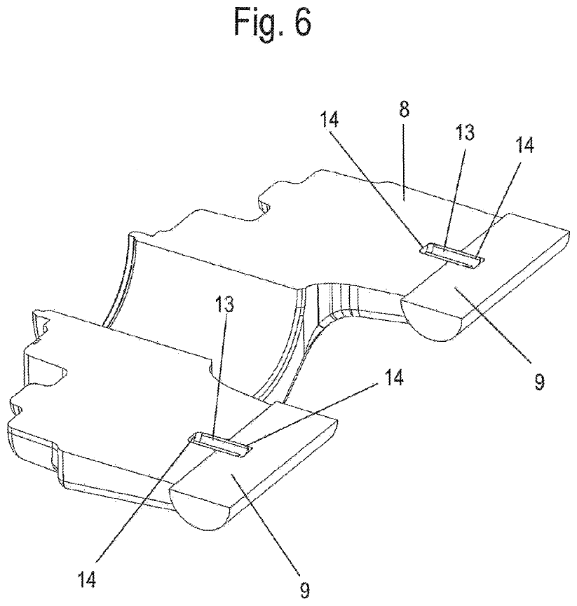

In the variant shown in FIGS. 5 and 6, two coaxially oriented rollers 9 are connected to the bridge 8 by the securing elements, the two rollers 9 being arranged with a spacing to one another so as to form an intermediate space. In this example, the securing elements are also in the form of clamping sleeves 13.

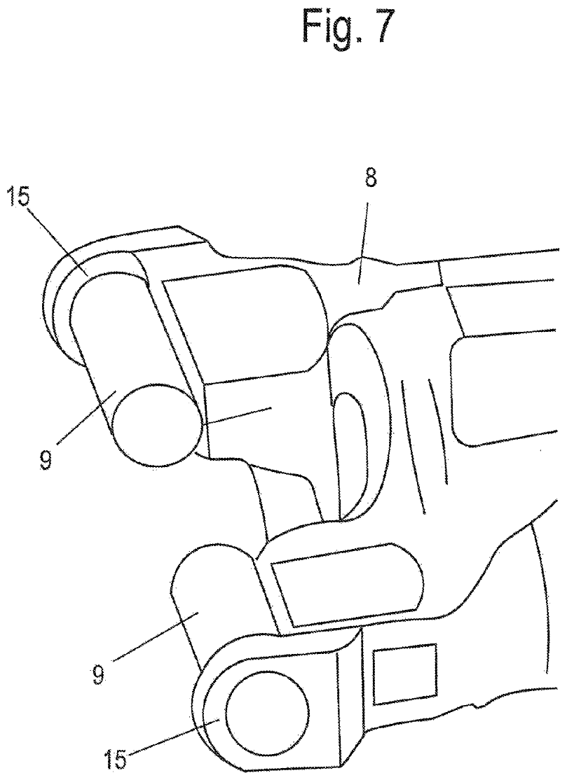

A further configuration of the brake-application device 2 according to the invention is depicted in FIG. 7. In said figure, it is possible to see the bridge 8 with the two rollers 9, which are each pressed, by way of their mutually averted end regions, into eyelets 15 of the bridge 8 and are held therein in a frictionally locking manner. These eyelets 15 are a constituent part of the bridge 8, that is to say that they are also formed integrally during the production of the bridge 8.

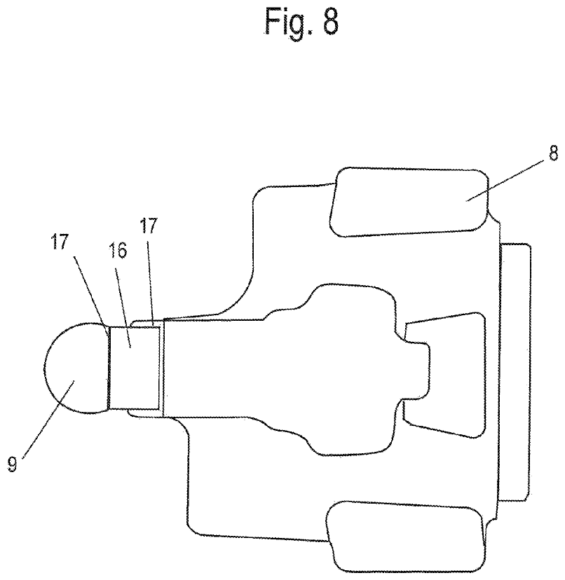

Lastly, FIG. 8 shows an embodiment of the invention in which a sheet-metal part 16 is provided as securing element and is pressed into a groove 17 of the bridge 8 and into a groove 17 of the roller 9 and thus a frictionally locking connection is produced.

### LIST OF REFERENCE SIGNS

1 Brake caliper
2 Brake-application device
3 Brake disc
4 Brake pad
5 Brake lever
6 Brake cylinder
7 Eccentric
8 Bridge
9 Roller
10 Bearing shell
11 Rolling body
12 Channel
13 Clamping sleeve
14 Bore
15 Eyelet
16 Sheet-metal part
17 Groove

1.-9. (canceled)

10. A brake-application device of a disk brake for a utility vehicle, comprising:
a pivotable brake lever which is supported, for one part, on an inner wall of a brake caliper, and, for another part, indirectly on a bridge which is arranged displaceably in the brake caliper and which bears at least one brake plunger, for which purpose a roller bearing assembly which bears against the bridge so as to be secured against rotation and displacement is provided between the brake lever and the bridge, wherein
the bridge and at least one roller of the roller bearing assembly are connected by at least one securing element.

11. The brake-application device of a disk brake as claimed in claim 10, wherein
the securing element is held in the bridge and in the at least one roller in a positively locking and/or frictionally locking manner.

12. The brake-application device of a disk brake as claimed in claim 10, wherein
the securing element comprises a clamping sleeve or a dowel pin, said clamping sleeve or said dowel pin being pressed into a bore in the bridge and in the at least one roller.

13. The brake-application device of a disk brake as claimed in claim 10, wherein
the securing element comprises a sheet-metal part which is pressed into a respective groove of the bridge and of the at least one roller.

14. The brake-application device of a disk brake as claimed in claim 10, wherein
two coaxially oriented rollers are provided which are arranged with a spacing to one another.

15. The brake-application device of a disk brake as claimed in claim 14, wherein
each of the two rollers are pressed into an eyelet of the bridge.

16. The brake-application device of a disk brake as claimed in claim 15, wherein
the eyelets are formed integrally on the bridge.

17. The brake-application device of a disk brake as claimed in claim 16, wherein
the eyelets are positioned at the opposite ends of the two rollers.

18. The brake-application device of a disk brake as claimed in claim 15, wherein
the eyelets are positioned at the opposite ends of the two rollers.

19. The brake-application device of a disk brake as claimed in claim 10, wherein
the at least one roller and the bridge are preassembled as a structural unit.
